(19) United States
(12) Patent Application Publication
(10) Pub. No.: US 2025/0076457 A1
(43) Pub. Date: Mar. 6, 2025

(54) MULTI-CHANNEL RADAR MEASUREMENT DEVICE USING TIME-FREQUENCY SPACE DISTRIBUTION

(71) Applicant: COMMISSARIAT A L'ENERGIE ATOMIQUE ET AUX ENERGIES ALTERNATIVES, Paris (FR)

(72) Inventors: Mykhailo ZARUDNIEV, Grenoble Cedex 09 (FR); Laurent OUVRY, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/817,503

(22) Filed: Aug. 28, 2024

(30) Foreign Application Priority Data
Aug. 29, 2023 (FR) 2309053

(51) Int. Cl. G01S 7/35; G01S 13/58

(52) U.S. Cl. CPC G01S 7/352; G01S 13/584

(57) ABSTRACT

The invention relates to a frequency-modulated, continuously transmitting radar measurement device including a generator configured to generate N first periodic radar signals, the frequency of each of said first periodic radar signals varies linearly as a function of time, in a frequency band B, over sections Tₓ of a part Tₜᵣₐₘₑ of a period T, the frequencies of said first periodic radar signals being different from one another at each time instant of the part Tₜᵣₐₘₑ; N transmit antennas; M receive antennas, each receive antenna being configured to receive a signal including echoes of the first periodic radar signals; a receive circuit configured to calculate, from the M signals, a range and/or a radial velocity and/or an angle, associated with a reflector detected by the radar measurement device.

### TECHNICAL FIELD OF THE INVENTION

One object of the invention is radar applications with several transmit and receive channels. The invention particularly relates to a radar measurement device forming a radar transceiver system providing a range measurement, an angular position measurement, a low power consumption and a high signal-to-noise ratio.

### PRIOR ART

The FMCW “Frequency Modulated Continuous Waveform” radar approach is based on the transmission and reception of continuous frequency-modulated signals. This approach has the following advantages compared with UWB (Ultra Wide Band) type radar approaches which are based on the transmission of pulses:
low calculation complexity, as this approach is based on converters with a low sampling rate;
simple generation of waveforms respecting a spectral emission mask as imposed by radio standards;
low instantaneous transmission power for an equivalent signal-to-noise ratio.

The FMCW radar approach makes it possible to determine the range between a radar device and one or more reflectors. By reflector, it is meant an object reflecting the radar wave. This approach also makes it possible to determine the radial component of a relative velocity between the radar device and the reflector, especially by using the Doppler effect.

FIG. 1 is a representation of an example of a periodic FMCW radar signal and an echo in a frequency versus time graph. The frequency of the periodic FMCW radar signal increases linearly over a frequency band B for a duration T_{frame}. The frequency of the periodic FMCW radar signal changes periodically over time according to a period T. After a time-of-flight T, an echo of the periodic FMCW radar signal is received. The frequency of the echo of the periodic FMCW radar signal follows the same change over time as the frequency of the periodic FMCW radar signal. The deviation between the instantaneous frequencies of the periodic FMCW radar signal and its echo, denoted as IF, can be determined especially using an FFT (Fast Fourier Transform) and enables the time-of-flight T to be calculated and the range between the FMCW radar device and the reflector at the origin of the echo considered to be deduced therefrom. The range D as a function of the time-of-flight is calculated as follows:

$$D = \frac{c \times τ}{2} \qquad [ Math . 1 ]$$

c being the velocity of light.

The FMCW approach can be used together with a so-called SIMO (Single Input Multiple Output) radar approach or a MIMO (Multiple Input Multiple Output) approach in order to determine, without performing radar scanning, an angle between a direction of a radar device and a direction of a reflector.

The SIMO and MIMO approaches use the phase difference, of a same wave reflected by a reflector, between several receiving antennas in order to determine this angle also called AOA (Angle of Arrival). In the SIMO approach, the angular resolution, that is, the smallest deviation that can be distinguished between the AOAs of two reflectors, is directly linked to the number of receiving antennas, for example, a SIMO radar including four receiving antennas allows an angular resolution of about thirty degrees, while a SIMO radar including eight receiving antennas allows an angular resolution of about fifteen degrees. However, each receiving antenna requires a dedicated processing chain, especially including an LNA (Low Noise Amplifier), a mixer, a filter and an ADC (Analogue to Digital Converter). Increasing the angular resolution of a SIMO radar therefore comes at the expense of complexity, overall size due to the size of the antenna array and power consumption by the radar device. To overcome this limitation, the MIMO approach provides an increase in angular resolution by increasing the number of transmitting antennas, for example, a MIMO radar device including two transmitting antennas and four receiving antennas allows angular resolution of about 15 degrees. However, this approach requires the reflected waves, also called echoes, from each transmitting antenna to be distinguished in the signal received by a receiving antenna.

FIG. 2 is a schematic representation of an example of a transmitting and receiving antenna arrangement according to the SIMO and MIMO approaches. An angle θ is the angle formed between a direction y of a SIMO or MIMO radar measurement device and the direction of a reflector, θ is the AOA. The upper part of the figure shows an example of SIMO architecture comprised of a transmitting antenna and 4 receiving antennas, each receiving antenna is separated by a range d. The radar signal received by one antenna has travelled an additional range d sin(θ) compared with the adjacent receiving antenna. This additional range causes a phase shift between the signals received by each of the transmitting antennas. This phase shift can be determined using a so-called “angle FFT” and then used to determine θ. The lower part of the figure shows an example of MIMO architecture comprised of two transmitting antennas and 4 receiving antennas. The two transmitting antennas are separated by a range 4d. An echo of the signal transmitted by the second transmitting antenna will therefore have travelled an additional range of 4d sin(θ) compared with an echo of the signal transmitted by the first transmitting antenna.

One way of distinguishing between echoes from the different transmitting antennas is called TDM (“Time Division Multiplexing”). A TDM-MIMO radar device transmits a frame consisting of several time slots, each time slot is transmitted by a separate transmitting antenna, this way the different transmitting antennas do not transmit simultaneously and an echo received by a receiving antenna at a given time instant is from the transmitting antenna transmitting at that time instant. The time-of-flight, that is, the round-trip duration of the wave reflected by the reflector, is generally short compared with the duration of a time slot. This way, called TDM, has the drawback of under-utilising the transmission capacity of a radar device. Indeed, only one of the transmitting antennas can operate at a given time instant. In addition, the frame transmitted by a TDM-MIMO radar device has to be long enough to contain a time slot for each transmitting antenna, which limits the duration for which the device can be put on standby between two transmit-receive cycles. This limitation on the standby duration increases accordingly the power consumption of the TDM-MIMO radar device.

Another way of distinguishing between the echoes from different transmitting antennas is to modulate the phase of the signal transmitted by each transmitting antenna, an example of this way applicable to a MIMO radar device including two transmitting antennas is called BPM (“Binary Phase Modulation”). In this example, the phase of the signal transmitted by the second transmitting antenna is shifted by 180° with respect to the phase of the signal transmitted by the first transmitting antenna. This allows a MIMO radar device to transmit simultaneously on each of its antennas, with different phase shifts being applied to the signals transmitted by each antenna. However, this way has the drawback of suffering a lot of interference between the signals transmitted by each antenna and phase demodulation errors, as the phase modulation of a signal is often incorrectly interpreted when the received signals are processed. The transmitting antennas of a MIMO radar device using phase modulation are therefore often confused with each other when the signals received by the receiving antennas are processed, which causes degradation of the angular resolution and range resolution of such a device.

### DESCRIPTION OF THE INVENTION

The present invention remedies the above drawbacks by providing a frequency-modulated, continuously transmitting radar measurement device.

Said frequency-modulated, continuously transmitting radar measurement device includes:
a generator configured to generate N first periodic radar signals, N>1, the frequency of each of said first periodic radar signals varies linearly as a function of time, in a frequency band B, over sections Tₓ of a part Tₜᵣₐₘₑ of a period T, the frequencies of said N first periodic radar signals being different from one another at each time instant of the part Tₜᵣₐₘₑ;
N transmit antennas, each transmit antenna being configured to transmit one of the first N periodic radar signals;
M receive antennas, M>1, each receive antenna being configured to receive a signal including echoes of the first periodic radar signals;
a receive circuit configured to:
   receive M signals, respectively received by the M receive antennas,
   calculate, from the M signals, at least one parameter associated with a reflector detected by said radar measurement device, said parameter being either a range, a radial velocity or an angle.

By reflector, it is meant, for example, an object on which radar signals are reflected and whose range and/or radial velocity and/or angle to the radar measurement device is to be calculated.

By radial velocity, it is meant the component of the relative velocity of the reflector with respect to the radar device along the direction formed by a straight line passing through the reflector and the radar device.

By angle between the reflector and the radar device, it is meant an angle, also called AOA, formed between said direction and an axis characteristic of the radar device.

By “echoes of the first periodic radar signals”, it is meant the periodic radar signals at the receive antennas of the radar measurement device, from the reflection of the first periodic radar signals on the reflector.

By a periodic radar signal whose frequency varies, it is meant a signal intended to be transmitted by at least one transmit antenna of a radar device and whose frequency varies. The variation in this frequency is periodic according to the period T.

The part Tₜᵣₐₘₑ of the period T, said period T according to which the frequencies of the first periodic radar signals vary, is divided into several sections. Within each section, the value of the frequency of each first periodic radar signal varies linearly.

Such arrangements enable the radar measurement device to use the FMCW approach to estimate the range and/or radial velocity of one or more reflectors, while benefiting from the advantages inherent in this approach.

Such arrangements enable the radar measurement device to use the MIMO approach enabling the AOA to be estimated while using the different transmitting antennas simultaneously. The first periodic radar signals transmitted by each transmitting antenna will cause little or no interference with each other because the frequency of each first periodic radar signal is different at each time instant from the frequency of the other first periodic radar signals. The echoes from each transmitting antenna will also be quite distinct from each other, enabling the AOA to be estimated accurately.

In particular implementations, the invention may further include one or more of the following characteristics, taken individually or according to any technically possible combination.

According to one embodiment, for each first periodic radar signal when the frequency of the first periodic radar signal considered, at the end of one of the sections Tₓ, is not a limit of the frequency band B, the phase of the first periodic radar signal considered, at the end of the section Tₓ considered, is equal to the phase of the first periodic radar signal considered at the beginning of one of the other sections Tₓ.

By “limit of the frequency band B”, it is meant, for example, when the frequency band B extends from a frequency fₘᵢₙ to a frequency fₘₐₓ, B=[fₘᵢₙ; fₘₐₓ], the frequency fₘᵢₙ or the frequency fₘₐₓ.

By “phase of a periodic signal”, it is meant the instantaneous phase of the periodic signal in question. Within the context of a sinusoidal expression of the periodic signal, this is the argument of the sine function. By contrast, the value of the argument of the sine function at the beginning of the signal (at t=0) is called herein the initial phase.

Such an arrangement enables, after rearranging the sections of the echoes of the first periodic radar signals, phase continuity of the echoes of the first periodic radar signals over all the parts Tₜᵣₐₘₑ. This phase continuity over the part Tₜᵣₐₘₑ makes it possible to estimate the range of the reflector using an FFT (Fast Fourier Transform) applied to the entire part Tₜᵣₐₘₑ. The range resolution thus obtained is c/2B, c being the velocity of light and B the FMCW frequency band.

By range resolution, it is meant the smallest range deviation between two reflectors that can be distinguished by the radar measurement device.

By contrast, in the absence of phase continuity between the sections of the first periodic radar signals, the estimation of the range of the reflector will be performed using FFTs applied to each section Tx. The range resolution thus obtained is cX/2B, X being the number of sections. The range resolution would therefore be greater (corresponding to degraded performance).

According to one embodiment, the generator includes N synchronised digital to analogue converters, known as DACs.

As a function of a digital signal, each DAC can generate a periodic analogue signal at a frequency distinct from the periodic analogue signals generated by the other DACs. As the DACs are synchronised, they can also generate periodic analogue signals in phase agreement. Said first periodic radar signals can be generated using the DACs.

According to one embodiment, the generator includes N polar modulators, each polar modulator being configured to generate a signal from which one of said first periodic radar signals is generated.

Each polar modulator can provide a frequency shift for the signal it generates, which makes it possible to ensure that the frequency of each first periodic radar signal is different from the frequency of the other first periodic radar signals at each time instant of the part Tₜᵣₐₘₑ. The signal generated by each polar modulator can be used as an input, for example, of a multiplexer which will generate one of said first periodic radar signals as an output.

According to one embodiment, the receive circuit includes N×M mixers, each mixer being configured to perform a heterodyne mixing of one of the M signals with one of N second periodic radar signals, each second periodic radar signal being generated from one of said N first periodic radar signals.

By “heterodyne mixing”, it is meant mixing produced by, for example, a mixer, which produces from two signals of respective frequencies f₁ and f₂ and of respective initial phases φ₁ and φ₂, a signal formed of several components including especially a component of frequency f₃=f₁−f₂ and of initial phase φ₃=φ₁−φ₂. Considering that each second periodic radar signal is one of the first periodic signals and that each first periodic radar signal has a corresponding second periodic radar signal. The signal as an output of each mixer could, for example, be filtered using a low-pass filter to retain only the component of frequency f₃=f₁−f₂ and initial phase φ₃=φ₁−φ₂. This makes it possible to easily obtain the frequency deviation, also known as the beat frequency, denoted as IF, between a first periodic radar signal and its echo. This IF is directly proportional to the time-of-flight, denoted as T, and therefore to the range between the radar measurement device and the reflector. The initial phase of the signal from each mixer will also enable the AOA of the reflector to be determined.

According to one embodiment, the second periodic signal has a time delay known as a focus delay, denoted as R_{focus}, relative to the first periodic radar signal from which the second periodic radar signal is generated.

The focus delay R_{focus}, by being configured to be close to the time-of-flight τ, makes it possible to overcome the windowing effects from which FMCW radar measurement devices can suffer when the range from the reflector increases or when the duration Tₜᵣₐₘₑ is reduced.

According to one embodiment, the first N periodic radar signals are generated from a reference periodic radar signal whose frequency varies linearly in the frequency band B over a period T_{ref}.

By reference periodic radar signal, it is meant an FMCW radar signal according to prior art. The period T_{ref} may be equal to the period T or the value of the period T_{ref} may be equal to the value of the part Tₜᵣₐₘₑ.

Sections of the reference periodic radar signal may be used to generate the sections Tₓ of the first periodic radar signals, by using different orders of arrangement of the sections of the reference periodic radar signal for each first periodic radar signal.

According to one embodiment, the first N periodic radar signals are generated by applying time shifts to the reference periodic radar signal.

By applying time shifts to the reference periodic radar signal, first periodic radar signals are generated with frequencies varying in the band B and whose frequencies at each time instant may be different by using different time shifts for the generation of each first periodic radar signal.

According to one embodiment, the variation period T_{ref} of the frequency of the reference periodic radar signal is equal to the part Tₜᵣₐₘₑ and the first periodic radar signal of index k, k being an integer of between 1 and N, is generated by applying a time shift to the reference periodic radar signal

$${D}_{k} = ( k - 1 ) \times \frac{{T}_{frame}}{N} . \qquad [ Math . 2 ]$$

The duration of each section Tₓ is defined by the difference between each time shift Dₖ and the time shift of previous index Dₖ₋₁.

This time shift of index k ensures that the duration of each section Tₓ is equivalent to that of the other sections Tₓ and that the deviation between the frequencies of the first periodic radar signals at each time instant is maximum for a frequency band B used.

According to one embodiment, a duration of each section Tₓ and a frequency band covered by each section Tₓ are configured according to a section arrangement code.

The use of a section arrangement code to configure the duration and frequency band of each section Tₓ makes it possible to generate the first N periodic radar signals while limiting potential interference with other periodic signals present in the environment of the device according to the invention.

### BRIEF DESCRIPTION OF THE FIGURES

The invention will be better understood upon reading the following description, which is given by way of non limiting example, with reference to the figures:

FIG. 1 a representation of an example of a periodic FMCW radar signal and an echo in a frequency versus time graph,

FIG. 2 a schematic representation of an example of a transmitting and receiving antenna arrangement according to the SIMO and MIMO approaches,

FIG. 3 a representation of examples of first periodic radar signals and echoes according to the invention in a frequency versus time graph,

FIG. 4 a schematic representation of an example of a radar measurement device according to the invention,

FIG. 5 a schematic representation of examples of steps for generating first radar periodic signals according to the invention.

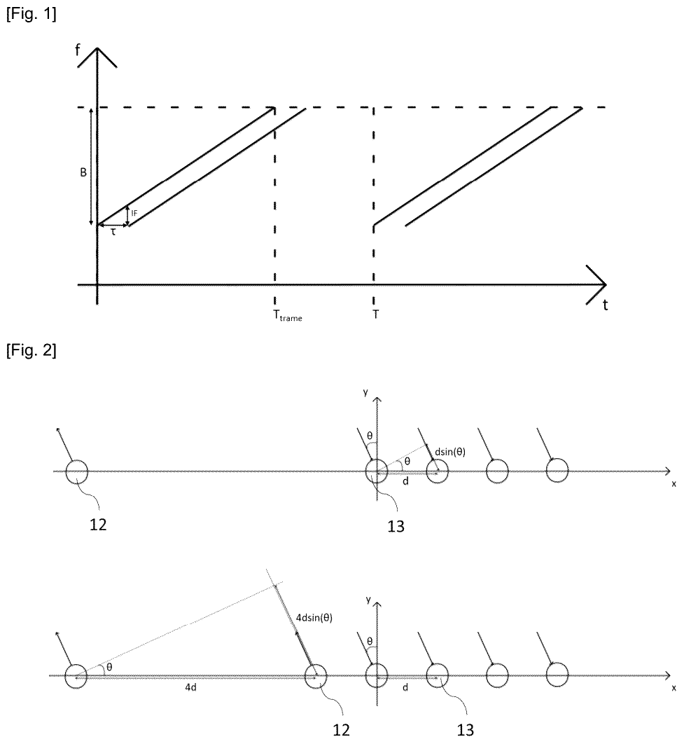

In these figures, identical references from one figure to the other refer to identical or similar elements. For reasons of clarity, the elements represented are not necessarily to a same scale, unless otherwise stated.

### DETAILED DESCRIPTION OF THE INVENTION

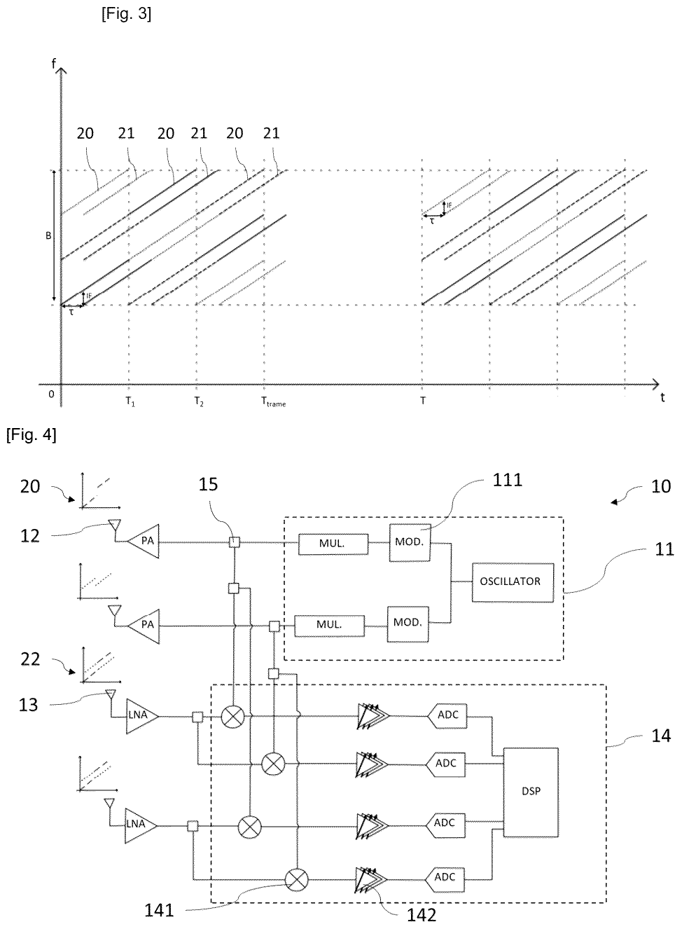

FIG. 3 is a representation of examples of first periodic radar signals 20 and echoes 21 according to the invention in a graph representing the frequency versus time. In this example of embodiment, 3 first periodic radar signals 20 are represented. The frequency of each first periodic radar signal 20 changes linearly as a function of time, in a frequency band B, over sections Tₓ (in this example N=3 and there are 3 sections) of a part Tₜᵣₐₘₑ of a period T. The first periodic radar signals 20 are transmitted during the part Tₜᵣₐₘₑ.

Each first periodic radar signal 20 is transmitted by a transmit antenna of a radar measurement device 10 according to the invention. A reflector reflects the first periodic radar signals 20, which induces echoes 21 of the first periodic radar signals. The reflector may especially be characterised by a radar equivalent surface. Each first periodic radar signal 20 induces an echo 21 which is received by the receive antennas 13 of the radar measurement device 10 according to the invention, after a time-of-flight τ. Each receive antenna 13 of the radar device 10 according to the invention receives a signal 22, this signal includes the echoes 21 of each first periodic radar signal 20 caused by at least one reflector.

The frequency of each first periodic radar signal 20 is different from the frequencies of the other first periodic radar signals 20 at each time instant of the part Tₜᵣₐₘₑ. In this way, the first periodic radar signals 20 transmitted by each transmit antenna 12 do not cause interference with each other.

The frequency shift between a first periodic radar signal 20 and its echo 21, also called IF frequency deviation, makes it possible to calculate a range between the radar measurement device and the reflector that caused the echo 21 considered.

A receive circuit 14 of the radar device 10 according to the invention will be able, from at least one signal 22 received by a receive antenna 13, to determine the IF associated with a reflector and then, from this IF, to calculate the range between the radar measurement device and the reflector considered. Several reflectors at different ranges will each cause an echo 21 with a distinct IF, making it possible to calculate the range of each reflector.

In addition, after reception of the echoes 21 of the first periodic radar signals 20, the echo 21 of each first periodic radar signal 20 is distinct in frequency from the echoes of the other first periodic radar signals 20. As the time-of-flight τ is considered to be small compared with the transmission duration Tₜᵣₐₘₑ, the echo 21 close in frequency to one of the first periodic radar signals 20 is the echo 21 of the first periodic radar signal 20 considered. This makes it possible to distinguish between the echoes of the first periodic radar signals 20 transmitted by each transmit antenna 12 of the radar measurement device 10 according to the invention. The receive circuit 14 of the radar measurement device 10 according to the invention can then determine a phase shift between the echoes 21 of the first periodic radar signals 20 transmitted by each transmit antenna 12. By phase shift, it is meant an initial phase difference.

The receive circuit can also determine a phase shift between the signals received by each receive antenna.

In this way, the device 10 according to the invention can implement a MIMO architecture enabling the AOA of a reflector to be calculated while utilising the full transmission capacity of the radar device according to the invention (each transmitting antenna transmits simultaneously).

In addition, when the frequency of each first periodic radar signal 20 at the end of a section Tₓ (T₁ or T₂ or Tₜᵣₐₘₑ in FIG. 3) is not the maximum frequency of the frequency band B, the phase of the first periodic radar signal considered at the end of the section Tₓ considered is equal to the phase of the first periodic radar signal 20 at the beginning of one of the other sections Tₓ. This makes it possible, for each echo of the first periodic radar signal, after the sections have been rearranged, for example digitally, to maintain continuity phase of the echo considered over the part Tₜᵣₐₘₑ. By phase, it is meant the instantaneous phase of a periodic signal. Within the context of a sinusoidal expression of the periodic signal, this is the argument of the sine function. By contrast, the value of the argument of the sine function at the beginning of the signal (at t=0) is called herein the initial phase. The phase continuity between the sections of the first periodic radar signals 20 allows phase continuity over the part Tₜᵣₐₘₑ of the signals 22 received by the receive antennas. These signals 22 can be processed directly or indirectly (after one or more transforms) by virtue of an FFT (Fast Fourier Transform) over the whole part Tₜᵣₐₘₑ in order to determine frequency deviations IFs. In the absence of this phase continuity on the part Tₜᵣₐₘₑ, FFTs will make it possible to process the part Tₜᵣₐₘₑ section by section (each section having phase continuity), which degrades the accuracy of determining IFs and therefore degrades the range resolution of the radar measurement device.

In the case N=3, the first periodic radar signals can, for example, be generated according to the following equations:

$${s}_{1} = \{ \begin{matrix}sin ( 2 π ( ( {f}_{c} - B / 2 ) t + α {t}^{2} ) ) , ∀ t ∈ [ 0 , {T}_{1} ) \\ sin ( 2 π ( ( {f}_{c} - B / 2 ) ( t - {T}_{1} ) + {α ( t - {T}_{1} )}^{2} ) ) , ∀ t ∈ [ {T}_{1} , {T}_{2} ] \\ sin ( 2 π ( ( {f}_{c} - B / 2 ) ( t + {T}_{1} ) + {α ( t + {T}_{1} )}^{2} ) ) , ∀ t ∈ [ {T}_{2} , {T}_{frame} ]\end{matrix} \qquad [ Math . 3 ]$$

S₁ being the first periodic radar signal 20 of index 1 (represented by a solid line in FIG. 3), f_{c} being the centre frequency of the frequency band B and a being the variation slope of the frequency.

$${s}_{2} = \{ \begin{matrix}sin ( 2 π ( ( {f}_{c} - B / 2 ) ( t - {T}_{1} ) + {α ( t - {T}_{1} )}^{2} ) ) , ∀ t ∈ [ 0 , {T}_{1} ] \\ sin ( 2 π ( ( {f}_{c} - B / 2 ) ( t + {T}_{1} ) + {α ( t + {T}_{1} )}^{2} ) ) , ∀ t ∈ [ {T}_{1} , {T}_{2} ] \\ sin ( 2 π ( ( {f}_{c} - B / 2 ) t + α {t}^{2} ) ) , ∀ t ∈ [ {T}_{2} , {T}_{frame} ]\end{matrix} \qquad [ Math . 4 ]$$

S₂ being the first periodic radar signal 20 of index 2 (represented by a large dotted line in FIG. 3).

$${s}_{3} = \{ \begin{matrix}sin ( 2 π ( ( {f}_{c} - B / 2 ) ( t - {T}_{2} ) + {α ( t - {T}_{2} )}^{2} ) ) , ∀ t ∈ [ 0 , {T}_{1} ] \\ sin ( 2 π ( ( {f}_{c} - B / 2 ) t + α {t}^{2} ) ) , ∀ t ∈ [ {T}_{1} , {T}_{2} ] \\ sin ( 2 π ( ( {f}_{c} - B / 2 ) ( t + {T}_{2} ) + {α ( t + {T}_{2} )}^{2} ) ) , ∀ t ∈ [ {T}_{2} , {T}_{frame} ]\end{matrix} \qquad [ Math . 5 ]$$

S₃ being the first periodic radar signal 20 of index 3 (represented by a small dotted line in FIG. 3).

FIG. 4 is a schematic representation of an example of a radar measurement device 10 according to the invention. According to an embodiment, a generator 11 includes, in the example represented, N=2 polar modulators 111. Each polar modulator 111 generates a signal from which a first periodic radar signal 20 is created, for example, using a multiplexer “MUL.” and then a power amplifier “PA”.

The frequency of each signal generated by one of the polar modulators 111 is different at each time instant from the frequency of the signals generated by the other polar modulators 111. In this way, the frequency of each first periodic radar signal 20 is different at each time instant from the frequency of the other first periodic radar signals 20. Each first periodic radar signal 20 is transmitted by at least one transmit antenna (one transmit antenna per first signal in the example represented).

According to one embodiment not represented, the generator 111 includes N digital to analogue converters (DACs). Each first signal 20 is generated using a digital to analogue converter from a digital signal.

The radar measurement device 10 also includes M=2 (in the example represented) receive antennas. Each receive antenna is configured to receive a signal 22 including, if a reflector is present in a visibility zone of the radar, the echoes of the first signals 20. Each signal 22 may, for example, be amplified by an LNA (Low Noise Amplifier) and then be mixed according to a heterodyne mixing by a mixer 141 with a second periodic radar signal generated from one of the first signals 20. In the example represented in [FIG. 4], each second periodic radar signal is one of the first periodic radar signals 20, from a splitter 15, and each first signal 20 has a corresponding second periodic radar signal. Heterodyne mixing makes it possible to produce a mixed signal including several components, including one of frequency f₃=f₁−f₂ and initial phase φ₃=φ₁−φ₂. The frequencies f₁ and f₂ and the initial phases φ₁ and φ₂ being respectively the frequencies and the initial phases of the signal 22 and of the second periodic radar signal at an input of one of the mixers 141. A low-pass filter 142 makes it possible to isolate the component of frequency f₃ and initial phase φ₃, which can then be digitised using an ADC (Analogue to Digital Converter). The receive circuit 14 of the radar measurement device 10 includes, for example, a digital signal processor DSP configured to make FFTs for calculating the range between the reflectors and the radar measurement device and the AOAs of the reflectors.

According to one embodiment not represented, the receive circuit 14 may not include a mixer 141. The signals 22 received can be digitised directly as well as the first signals 20 and the frequency deviations IFs determined without heterodyne mixing but by digital processing only. However, such an embodiment has the drawback of requiring ADCs with a much higher sampling frequency in order to be able to digitise the signals 22 directly without losing useful information.

According to one embodiment not represented, each second periodic radar signal has a time delay R_{focus} with respect to the first signal 20 from which it is generated. A radar measurement device as described in application FR3125887 allows this time delay and uses it, by configuring it to be close to the time-of-flight τ, to reduce the IFs (which makes it possible to use ADCs with even lower sampling frequencies) and to avoid windowing effects (producing ghost reflector images) when the range between the reflector and the device is such that the time-of-flight τ is greater than the period T.

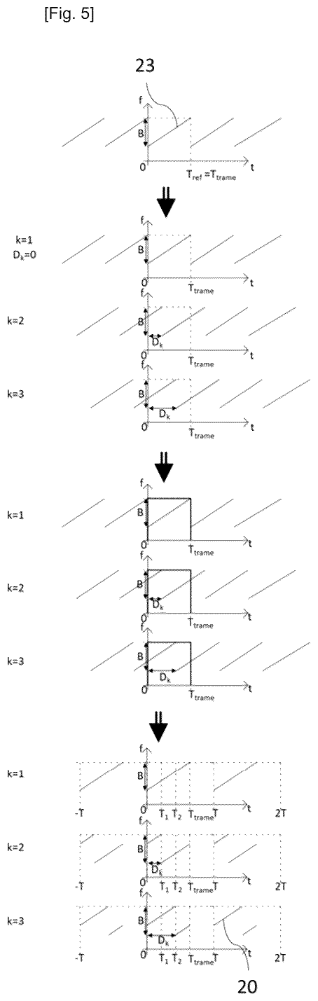

FIG. 5 is a schematic representation of examples of steps for generating first radar periodic signals according to the invention. In this example, the radar measurement device 10 includes at least N=3 transmit antennas. A reference periodic radar signal 23 is represented, it is an FMCW signal as present in prior art. The frequency of the reference periodic radar signal varies linearly in the frequency band B. The variation in the frequency of the reference periodic radar signal 23 is periodic according to a period T_{ref}. Each section Tₓ of the first periodic radar signals 20 may be generated from a section of the reference periodic radar signal 23, for example digitally, when the first periodic radar signals 20 are generated using DACs.

According to one embodiment, time shifts Dₖ can be applied to the reference periodic radar signal 23 to generate the first periodic radar signals 20. In an example not represented, the period T_{ref} is equal to the period T and each section Tₓ is from the reference periodic radar signal 23 shifted by a time shift Dₖ to which a time window, also called gate, of width Tₓ is applied, beginning at the beginning time instant of the section Tₓ considered. Each first periodic radar signal can then consist, using a switch for example, of the different sections Tₓ generated from the reference periodic radar signal 23. This makes it possible to generate the first periodic radar signals 20 in such a way that their frequencies are different from one another at each time instant and in such a way that the signals 22 formed by the echoes 21 and received by the receive antennas 13 of the radar measurement device 10 have phase continuity over the part Tₜᵣₐₘₑ of the period T.

According to one embodiment represented in [FIG. 5], T_{ref}=Tᵣₐₘₑ. That is, the duration of the variation period T_{ref} of the frequency of the reference periodic radar signal 23 is equal to the duration of the part Tₜᵣₐₘₑ of the period T of the first periodic radar signals 20. The first periodic radar signal of index k, k being an integer of between 1 and N, is generated from the reference periodic radar signal 23 to which is applied a time shift

$${D}_{k} = ( k - 1 ) \times \frac{{T}_{frame}}{N} . \qquad [ Math . 2 ]$$

Once the time shift has been applied, a time windowing of width Tₜᵣₐₘₑ beginning at the beginning of the part Tₜᵣₐₘₑ makes it possible to generate an intermediate signal of duration Tₜᵣₐₘₑ. The intermediate signal is then repeated according to the period T to form the first periodic radar signal 20 of index k. This way of generating the first periodic radar signals 20 especially allows an equal duration for each section Tₓ. This way also allows, for a given frequency band B, a maximum deviation between the frequency at each time instant of a first periodic radar signal 20 and the frequency of the other first periodic radar signals 20. Having a maximum deviation between the frequencies at each time instant of the first periodic radar signals makes it possible to limit interference between the first periodic signals 20 to a maximum when they are transmitted simultaneously.

According to one embodiment, a duration of each section Tₓ and a frequency band covered by each section Tₓ are configured according to a section arrangement code.

By section arrangement code, it is meant one or more digital or analogue signals including information representative of the duration and frequency band of each section Tₓ.

The use of a section arrangement code to configure the duration and frequency band of each section Tₓ makes it possible to generate the first N periodic radar signals, for example by leaving one or more parts of the frequency band B unused. This makes it possible to limit interference with other periodic signals, occupying this or these part(s) of the B frequency band, in the environment of the radar device according to the invention.

In another example, the section arrangement code will generate the first N periodic radar signals so as to limit the mean destructive interference experienced by the first periodic radar signals.

The section arrangement code can, for example, be used to configure the generation of the first N periodic radar signals by the polar modulators or by the DACs.

1. A frequency-modulated, continuously transmitting radar measurement device including:
a generator configured to generate N first periodic radar signals, N>1, the frequency of each of said first periodic radar signals varies linearly as a function of time, in a frequency band B, over sections Tₓ of a part Tₜᵣₐₘₑ of a period T, the frequencies of said first N periodic radar signals being different from one another at each time instant of the part Tₜᵣₐₘₑ;
N transmit antennas, each transmit antenna being configured to transmit one of the first N periodic radar signals;
M receive antennas, M>1, each receive antenna being configured to receive a signal including echoes of the first periodic radar signals;
a receive circuit configured to:
receive M signals, received by the M receive antennas respectively,
calculate, from the M signals, at least one parameter associated with a reflector detected by said radar measurement device, said parameter being either a range, a radial velocity or an angle,
wherein, for each first periodic radar signal, when the frequency of the first periodic radar signal considered, at the end of one of the sections Tₓ, is not a limit of the frequency band B, the phase of the first periodic radar signal considered at the end of the section Tₓ considered is equal to the phase of the first periodic radar signal considered at the beginning of one of the other sections Tₓ.

2. The radar measurement device according to claim 1, wherein a duration of each section Tₓ and a frequency band covered by each section Tₓ are configured according to a section arrangement code.

3. The radar measurement device according to claim 1, wherein the generator includes N synchronised digital to analogue converters, known as DACs.

4. The radar measurement device according to claim 1, wherein the generator includes N polar modulators, each polar modulator being configured to generate a signal from which one of said first periodic radar signals is generated.

5. The radar measurement device according to claim 1, wherein the receive circuit includes N×M mixers, each mixer being configured to perform heterodyne mixing of one of the M signals with one of N second periodic radar signals, each second periodic radar signal being generated from one of said first N periodic radar signals.

6. The radar measurement device according to claim 5, wherein the second periodic signal has a time delay known as the focus delay, denoted as R_{focus}, with respect to the first periodic radar signal from which the second periodic radar signal is generated.

7. The device according to claim 1, wherein the first N periodic radar signals are generated from a reference periodic radar signal whose frequency varies linearly in the frequency band B, according to a period T_{ref}.

8. The device according to claim 7, wherein the first N periodic radar signals are generated by applying time shifts to the reference periodic radar signal.

9. The device according to claim 8, wherein the variation period T_{ref} of the frequency of the reference periodic radar signal is equal to the part Tₜᵣₐₘₑ and wherein the first periodic radar signal of index k, k being an integer comprised of between 1 and N, is generated by applying to the reference periodic radar signal a time
$${shiftD}_{k} = ( k - 1 ) \times \frac{{T}_{frame}}{N} .$$
